(19) United States
(12) Patent Application Publication
(10) Pub. No.: US 2011/0232196 A1
(43) Pub. Date: Sep. 29, 2011

(54) Support Truss for Hinged Overhead Door

(75) Inventor: Stan Robinson, Vista, CA (US)

(73) Assignee: HYDROSWING, INC., Cottonwood, MN (US)

(21) Appl. No.: 12/853,482

(22) Filed: Aug. 10, 2010

Related U.S. Application Data
(60) Provisional application No. 61/317,566, filed on Mar. 25, 2010.

(51) Int. Cl. E06B 3/38; E05F 11/54

(52) U.S. Cl. 49/199; 49/358

(57) ABSTRACT

An overhead door for closing a building opening has load distributing support trusses extending along spaced vertical members of the door or door frame. Each support truss is secured to a respective door vertical member to extend transverse to the door in a generally downward direction when the door is in an overhead, open position. The trusses are substantially V-shaped. Each truss has first and second rails extending from respective ends of the truss to an apex. One or more trusses may be side trusses secured to vertical members defining opposite sides of the door. Each side truss has a pivot mount configured for pivotal connection to one end of a hydraulic ram for opening and closing the door.

### RELATED APPLICATION

The present application claims the benefit of co-pending U.S. provisional pat. App. Ser. No. 61/317,566, filed Mar. 25, 2010, the contents of which are incorporated herein by reference in their entirety.

### BACKGROUND

1. Field of the Invention

The present invention relates generally to overhead doors which are mounted to swing between a vertical closed position and a horizontal open position, and is particularly concerned with a support truss for a hinged overhead door.

2. Related Art

In some known overhead doors for closing a large opening in a garage, hanger, or other building, the door is moved between open and closed positions by one or more hydraulic rams acting between the side frame of the opening and the sides of the door. One such arrangement is described in U.S. Pat. No. 6,883,273, the contents of which are incorporated herein by reference in their entirety. One problem with such arrangements is the load involved in opening and closing very large doors, such as hangar doors.

### SUMMARY

Embodiments described herein provide for a hinged overhead door with side trusses attached to opposite sides of the door.

According to one embodiment, support trusses are attached to a large hangar door so as to distribute the load. The support trusses may be side trusses attached to opposite sides of the door, and may be built into the door during production, or may be retrofitted to an existing door. The trusses are configured to distribute the load of the large hangar door, allowing hangar doors to be built taller than 20 feet and to use shorter hydraulic rams for opening and closing the larger hangar door. The trusses also add strength and reduce material thickness in the hangar door.

Although the side or support trusses are described in conjunction with a hangar door, in alternative embodiments, support trusses may be used in conjunction with other overhead doors for use in closing openings allowing entry to buildings, especially for buildings (e.g., agricultural, aviation, commercial buildings and the like) with large openings (e.g., for accommodating trucks, tractors, airplanes, large farm equipment, large industrial equipment, and others vehicles/equipment through such opening). In one embodiment, one or more additional support trusses may be attached at spaced intervals to an inner face of the door. This is particularly useful for added strength and rigidity when a hanger door is extremely tall.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a perspective view of a hangar or other building including one embodiment of a large hangar or overhead door member (shown in an open position) with side trusses along sides of the door;

FIG. 2 is a side elevational view of the left hand side of door member of FIG. 1;

FIG. 3 is a front elevational view of the door member of FIG. 1;

FIG. 4 is a perspective view of one side truss of the door member of FIG. 1;

FIG. 5 is a front elevational view of the side truss of FIG. 5;

FIG. 6 is a right elevational view of the side truss of FIG. 5;

FIG. 7 is a top plan view of the side truss of FIG. 5;

FIG. 8A is a cross-sectional view of the side truss of FIG. 6 taken along line A-A;

FIG. 8B is a cross-sectional view of the side truss of FIG. 6 taken along line B-B;

FIG. 8C is a cross-sectional view of the side truss of FIG. 6 taken along line C-C;

FIG. 8D is a cross-sectional view of the side truss of FIG. 6 taken along line D-D;

FIG. 9 is an enlarged, partial front elevational view of a central portion of the side truss of FIG. 5;

FIG. 10 is a rear or inside perspective view of a modified hangar or other overhead door with a different support truss arrangement;

FIG. 11 is a top plan view of the door of FIG. 10; and

FIG. 12 is a front or outside perspective view of the hangar door of FIGS. 10 to 11.

### DETAILED DESCRIPTION

Certain embodiments as disclosed herein provide for support trusses for an overhead door such as a hangar door, and for an overhead door assembly incorporating support trusses, which may be side trusses located at opposite sides of the door. Additional support trusses may be located at other positions on the door.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention.

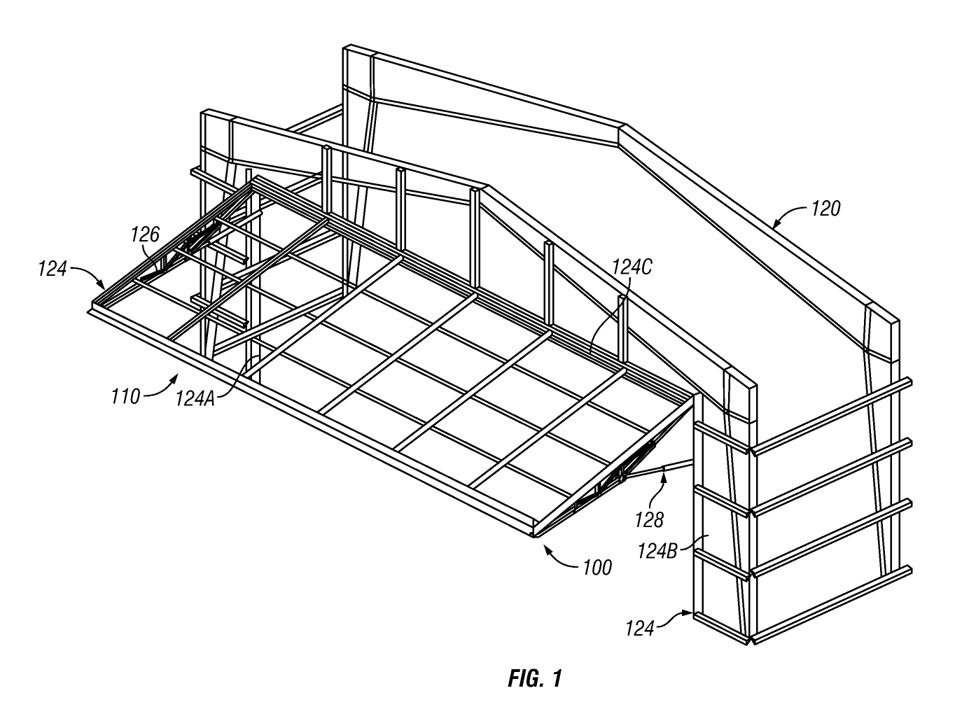

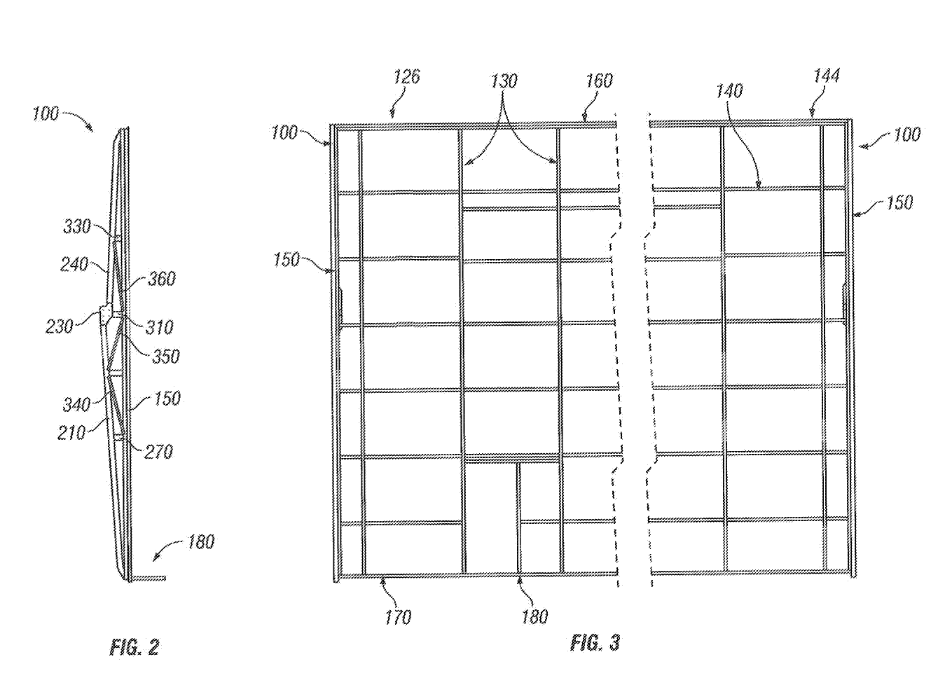

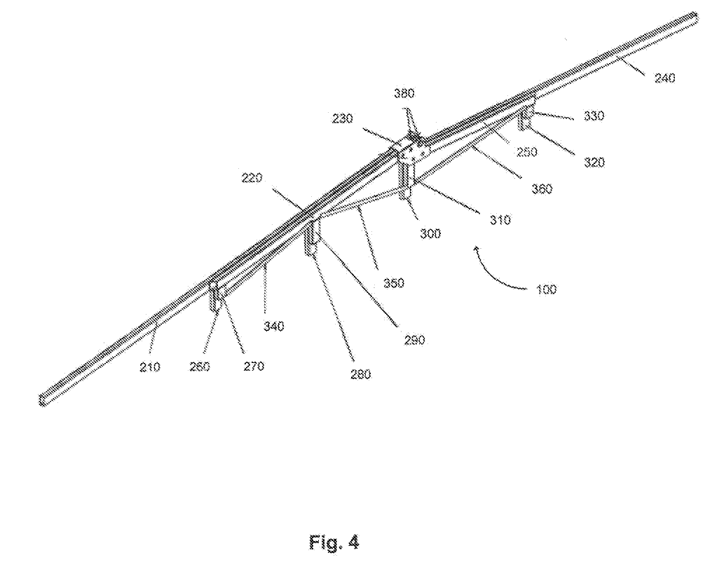

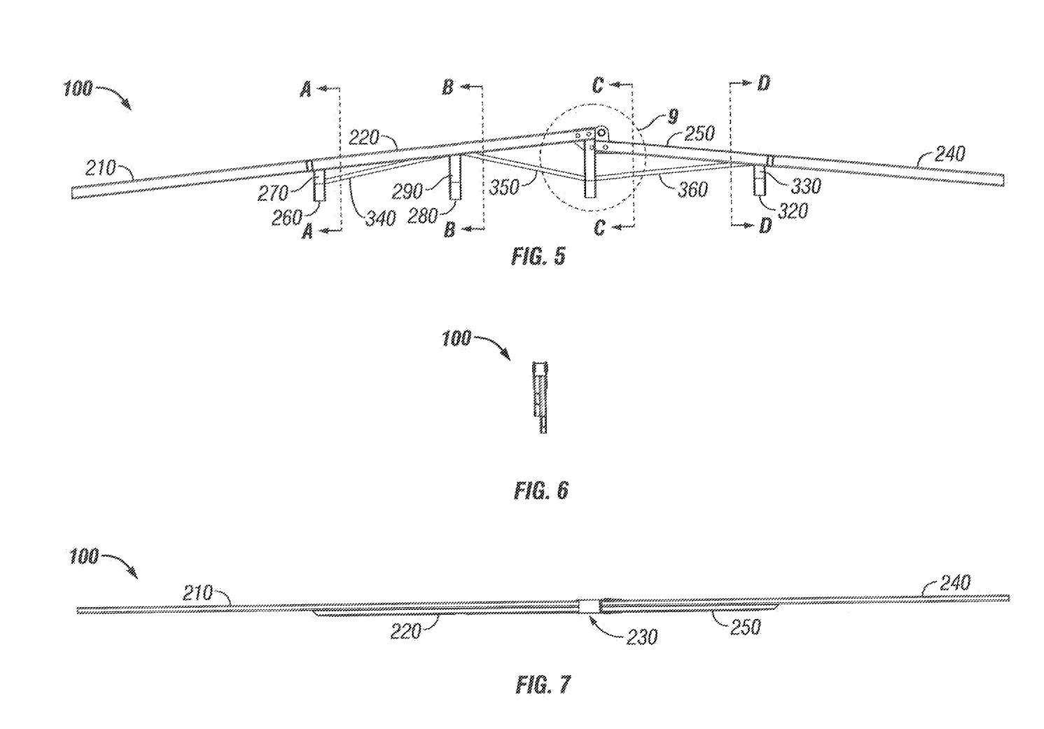

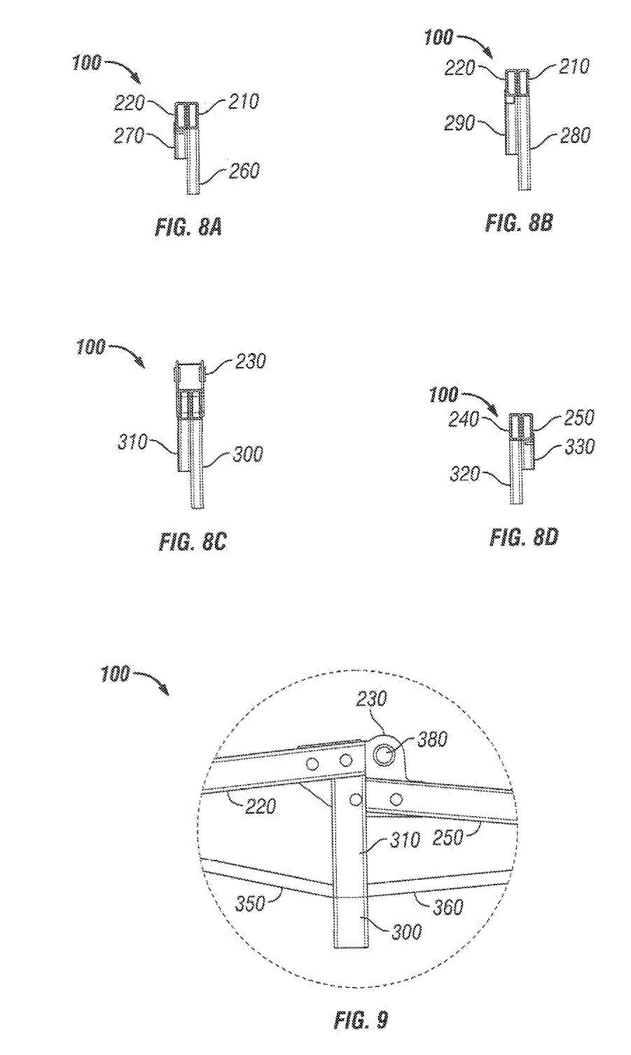

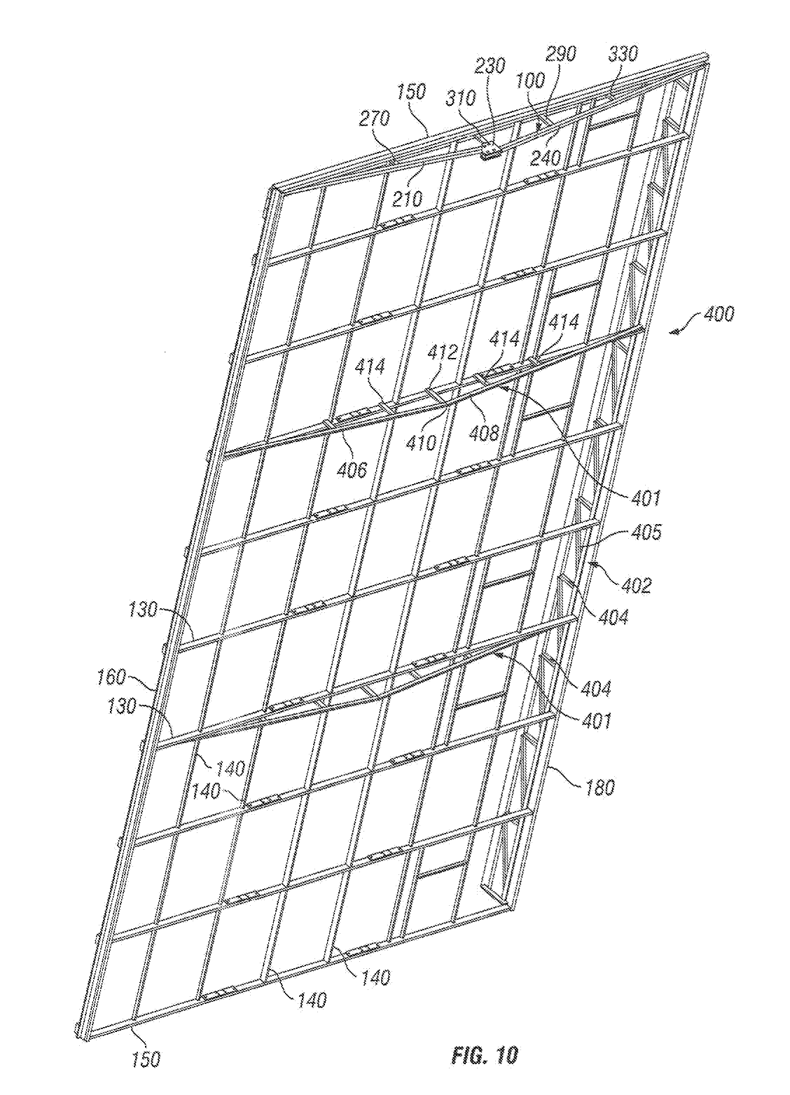

FIG. 1 illustrates one embodiment of an overhead door assembly 110 mounted in an opening of a building 120 such as a hangar or the like, while FIGS. 2 to 4 illustrate details of the door member and FIGS. 5 to 9 illustrate one embodiment of a side or support truss 100 which is incorporated in the door of FIGS. 1 to 4. As indicated above, although the side truss 100 is described in conjunction with a hangar door assembly 110, in alternative embodiments, the side truss 100 may be used with other types of door assemblies for buildings other than hangars, such as agricultural, aircraft, commercial buildings and the like, with large openings for accommodating trucks, tractors, airplanes, large industrial equipment, and the like. Before describing the side truss 100, the large movable hangar door assembly 110 will be generally described.

With reference to FIGS. 1-3, the large movable hangar door assembly 110 includes a door frame 124, a large hangar door member 126, and hydraulic cylinder(s) or rams 128 for opening and closing the door member 126 relative to the door frame 124.

The door frame 124 comprises two vertical support members 124A, B (e.g., steel tube jambs) and a horizontal support member 124C (e.g., a steel tube header).

The door member 126 (supporting grid structure only is shown) includes a plurality of vertical support members or elongate frame members 130 and a plurality of lateral support members 140 that form a door member supporting frame 144. The vertical support members 130 include opposite side vertical support members 150. The lateral support members 140 include a top lateral support member 160 and a bottom lateral support member 170. Hinges (not shown) may be provided along the top lateral support member 160 and the horizontal support member 124C to hingeably connect the door member 126 to the door frame 124. Extending from the bottom lateral support member 170 is a bottom truss 180. Tin or other skinning material may be attached to the lateral support members 140 and/or vertical support members 130. The door member 126 may include a doorway/door that one may use to enter and exit the hangar/building 120 when the hangar door assembly is closed. Side trusses 100 are secured to opposite sides of door member 126 as illustrated in FIGS. 1 to 3.

With reference to FIGS. 3-9, the side truss 100 will now be described in more detail. The side truss 100 includes an elongated lower inner rail 210 and a shorter parallel lower outer rail 220 joined by a joinder bracket 230 to an elongated upper inner rail 240 and a shorter parallel upper outer rail 250. The rails 210, 220, 240, 250 are substantially vertically oriented. The lower inner rail 210 is longer than the upper inner rail 240.

Lateral supports extend laterally at spaced intervals between the rails 210, 220, 240, 250 and the respective side of the door. Extending laterally from the rails 210, 220 at a lower point are inner lateral support 260 and outer lateral support 270. Extending laterally from the rails 210, 220 at a lower central point are central inner lateral support 280 and central outer lateral support 290. Extending laterally from the joinder bracket 230 are inner lateral support 300 and outer lateral support 310. Extending laterally from the rails 240, 250 at an upper point are inner lateral support 320 and outer lateral support 330. The rails 210, 220, 240, 250 and lateral supports 260, 270, 280, 290, 300, 310, 320, 330 are made of rectangular tubing. In one embodiment of a door which was around twenty feet in height, the rails and supports were of 4 by 2 inch steel rectangular tubing. The wall thickness of the tubing was 0.25 to 0.35 inches. Rails of other shapes and dimensions may be used in alternative embodiments, depending on the desired truss strength.

A lower angle brace/iron 340 connects lower outer support 270 and lower central outer support 290. A lower central angle brace/iron 350 connects lower central outer support 290 and upper central outer support 310. An upper central angle brace/iron 360 connects upper central outer support 310 and upper outer support 330. In one embodiment, each angle iron was a 1.5 by 1.5 inch angle iron, but alternative dimensions may be used depending on truss strength requirements.

The joinder bracket 230 is comprised of a plurality of steel plates and includes a steel bushing 380 there through. Ends of rails 210, 220, 240, 250 and ends of upper central inner support 300 and upper central outer support 310 are connected to the joinder bracket 230 by one or more fasteners (e.g., bolts, pins, welding).

Terminal ends of the inner and outer supports 260, 270, 280, 290, 300, 310, 320, 330 are connected to the door member supporting frame 144 at the opposite side vertical support members 150. As indicated above, the side trusses 100 may be built into the door member 126 with production of the door or may be later added/retrofitted to an existing door member in the field.

Opening and closing of the door member 126 with the side trusses 100 will now be described. As indicated above, the door member 126 is pivotally connected to the hangar/building 120 via the frame 124 at hinges for moving the door member 126 between a closed position and an open position. Each of the hydraulic cylinders 128 include a cylinder ram that moves in and out of a hydraulic cylinder for opening and closing the hangar door/roof assembly 110. The hydraulic cylinders 128 are pivotally connected at one end to the frame 124 and at an opposite end to the side truss 100 via the steel bushing 380 of the joinder bracket 230.

To raise the door member 126, the hydraulic cylinders 128 are actuated to cause the cylinder rams to move outwardly from the hydraulic cylinders. The extension of the cylinder rams forces the door member 126 upwardly, with the door member 126 pivoting upwardly at the hinges. When the door member 126 is raised, a plane (or other vehicle/equipment) can easily enter and exit the hangar/building 120 without contacting the door member 126.

To lower the door member 126, the hydraulic cylinders 128 are actuated to cause the cylinder rams to retract into the hydraulic cylinders. The retraction of the cylinder rams forces the door member 126 downwardly, with the hangar door/roof assembly 110 pivoting downwardly at the hinges. With the door member 126 closed, the plane (or other vehicle/equipment) inside of the hangar/building 120 is protected from the environment. It should be noted that weather-tight resilient seals (e.g., compressed foam seal) may be disposed along edges of the door member 126 and the hangar/building 120 (where the two come together).

The side trusses 100 distribute the load of the large hangar door member 126 as the hydraulic cylinders 128 raise and lower the large hangar door member 126. These side trusses allow much larger hangar doors than were available in the past (e.g., hangar doors taller than 20 feet) and to use shorter hydraulic rams for opening and closing the larger hangar doors. The side trusses 100 also add strength and allow material thickness in the hangar door member 126 to be reduced. In one example of a side truss designed for doors over 20 feet in height, the height of the truss at the apex was around 23 inches while the length of the inner rails 210, 240 were around ten to sixteen feet. The spacing between successive pairs of lateral supports 270, 290 and 290, 310 was around four feet while the spacing between supports 310 and 33 was around five feet. The length of lateral supports 260 and 320 was around 11 inches, the length of lateral support 280 was around 16 inches, and the length of the longest lateral support was around 20 inches.

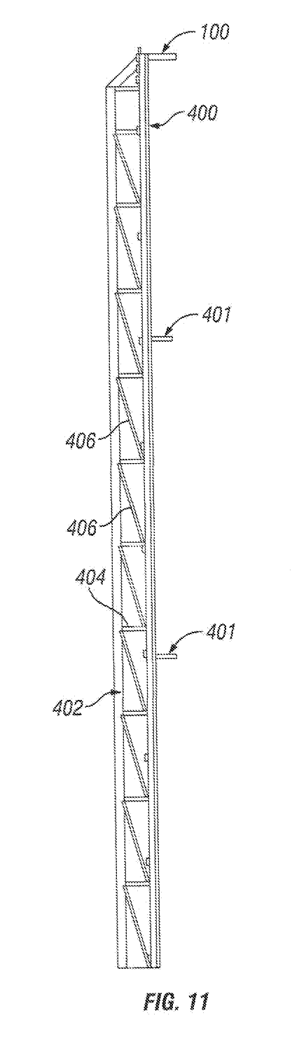

In the embodiment of FIGS. 1 to 9, side or support trusses are attached to opposite side members of the door. FIGS. 10 to 12 illustrate an alternative embodiment in which additional support trusses are incorporated in a modified door 400. Other parts of door 400 are identical to those of the previous embodiment, and like reference numbers are used for like parts as appropriate. In the door 400, a side truss 100 is attached to at least one door side member 150, while additional support trusses 401 are attached to other upright or vertical members 130 at spaced intervals across the width of the door. Three support trusses 100, 401 are provided in the illustrated embodiment, but a greater or lesser number may be used in alternative embodiments. Side trusses 100 may be attached to one or both of the door side members 150, and a single additional support truss 401 may be secured to a central vertical or elongate frame member 130, or two or more additional support trusses may be secured to spaced vertical or elongate frame members 130. Additional vertical support trusses spaced across the width of the door can be helpful for providing additional strength and stability if the door is extremely tall or wide, for example. The bottom truss 402 of the door 400 has cross bars 404 and angle braces 405 extending between opposite ends of adjacent cross bars 404, for additional support.

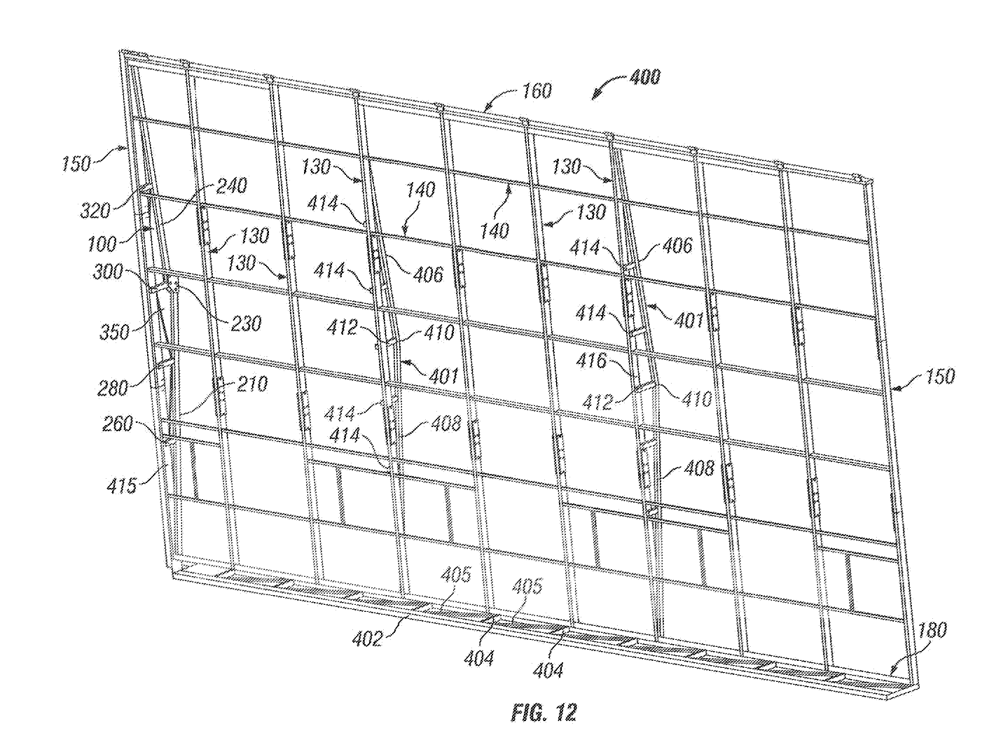

The additional support trusses 401 are similar in structure to the side truss 100 but have no joinder bracket 230 at the apex of the strut. Each support truss 401 is generally V-shaped, with upper and lower rails 406, 408 extending at an angle from the upper and lower end of the respective vertical member 130 and joined together at the apex 410 of the V-shape. A first, central lateral support 412 extends from the apex and is secured to a central location on vertical member 130. Additional lateral supports 414 parallel to central support bar 412 extend at spaced intervals from each rail 406, 408 and are joined to the vertical member 130. The lateral supports 412, 414 of support trusses 401 are all secured to the side face 416 of the respective vertical member 130. As in the previous embodiment, side support truss 100 has longer inner lateral supports 260, 280, 300, 320, respectively, which are secured to the inner face 415 of the side member 150, as best illustrated in FIG. 12, and shorter outer lateral supports 270, 290, 310, 330 on the outer side of the truss (FIG. 10). The support trusses 401 may also have inner and outer rails and inner and outer lateral supports, similar to the side trusses 100.

In the above embodiments, triangular or V-shaped support trusses are provided to reinforce the vertical support members of a hangar door frame. The support trusses may be provided only on the opposite side members of the door, and may be linked to hydraulic cylinders for opening and closing the door, as in FIGS. 1 to 9. For extremely tall doors, additional load bearing or load distributing support trusses may be attached to other vertical support members at spaced intervals across the width of the door, for example at the center or other locations between the side members, as illustrated in FIGS. 10 to 12. This provides additional strength and rigidity to the door as it is opened and closed.

While various embodiments of the present invention have been described above, it should be understood that they have been presented by way of example only, and not of limitation. Likewise, the various diagrams may depict an example architectural or other configuration for the disclosure, which is done to aid in understanding the features and functionality that can be included in the disclosure. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

As will become apparent to one of ordinary skill in the art after reading this document, the illustrated embodiments and their various alternatives can be implemented without confinement to the illustrated examples.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

We claim:

1. An overhead door for a building having an opening to be closed by the door, comprising:
a door having an upper member, opposite first and second side members, and a lower member defining a rectangular outer periphery of the door, the upper member being configured for pivotal mounting in the upper end of a door frame surrounding a building opening, whereby the door is movable from a vertical closed position to an upper, substantially horizontal open position;
at least a first load bearing side truss secured to the first side member of the door to extend along at least substantially the entire length of the side member in a direction transverse to the plane of the door, the side truss being substantially V-shaped and having an apex which extends generally downwards in the open position of the door; and
the apex of the side truss having a pivot mount configured for pivotal connection to one end of a hydraulic ram for opening and closing the door.

2. The door of claim 1, further comprising a second load bearing truss secured to the second side member of the door, the second load bearing truss being identical to the first load bearing side truss.

3. The door of claim 1, further comprising a plurality of vertical members extending between the upper and lower member of the door at spaced intervals across the width of the door, and at least one additional load bearing support truss secured to one of the vertical members to extend along substantially the entire length of the door parallel to the first load bearing side truss, the additional support truss being substantially V-shaped and having an apex which extends generally downwards in the open position of the door and inwards in the closed position of the door.

4. The door of claim 3, including a plurality of additional load bearing support trusses secured to spaced vertical members at spaced intervals across the width of the door.

5. The door of claim 2, wherein each side truss has opposite upper and lower ends in the closed position of the door, a first rail extending from the lower end towards the apex of the V-shape, a second rail extending from the upper end towards the apex of the V-shape, and a bracket joining the rails together at the apex.

6. The door of claim 5, wherein each rail comprises parallel inner and outer rails.

7. The door of claim 6, wherein the outer rail is shorter than the inner rail and terminates short of the respective rail end.

8. The door of claim 5, wherein each side truss further comprises a plurality of lateral supports extending at spaced intervals between the rails and the respective side member.

9. The door of claim 8, wherein one of the lateral supports of each side truss extends from the apex of the side truss towards the respective door side member and has an end secured to the respective side member.

10. The door of claim 8, wherein each lateral support comprises an inner support member and an outer support member extending alongside the inner support member.

11. The door of claim 10, wherein the outer support member is shorter than the inner support member.

12. The door of claim 8, wherein each side truss further comprises angle braces extending at an angle between each adjacent pair of lateral supports.

13. The door of claim 12, wherein the lateral supports of each side truss have first ends secured to the rails and second ends secured to the respective door side member, and the angle braces extend alternately from the first end of a first lateral support to the second end of a second lateral support, and from the second end of the second lateral support to the first end of a third lateral support.

14. The door of claim 5, wherein the bracket of at least one side truss includes the pivot mount.

15. The door of claim 14, wherein the bracket comprises a plurality of metal plates and the pivot mount comprises a metal bushing extending through the plates.

16. The door of claim 8, wherein the rails and lateral supports are made of steel rectangular tubing.

17. An overhead door assembly for a building having an opening to be closed by a door, comprising:
a door frame adapted to be secured in a building opening, the frame comprising a horizontal support member having opposite ends and first and second vertical members fixedly mounted to the respective ends of the horizontal support member;
a door member having upper and lower horizontal ends and opposite first and second sides, the upper horizontal end being pivotally mounted to the horizontal support member of the door frame for movement between a vertical closed position and an at least substantially horizontal open position;
a first load bearing side truss mounted to the first side of the door member and a second load bearing side truss mounted to the second side of the door member;
each side truss being substantially V-shaped and having an apex which extends generally downwards in the open position of the door; and
at least one hydraulic cylinder having a ram movable between retracted and extended positions, the cylinder having a first end pivotally mounted to a portion of the first vertical member and a second end pivotally mounted to the apex of the first side truss, whereby movement of the ram between the retracted and extended positions simultaneously rotates the door member between the closed and open positions.

18. The assembly of claim 17, further comprising a second hydraulic cylinder having a ram movable between retracted and extended positions, the second cylinder having a first end pivotally mounted to a portion of the second vertical member and a second end pivotally mounted to the apex of the second side truss.

19. The door of claim 17, wherein each side truss has opposite upper and lower ends in the closed position of the door, a first rail extending from the lower end towards the apex of the V-shape, a second rail extending from the upper end towards the apex of the V-shape, and a bracket joining the rails together at the apex.

20. The door of claim 19, wherein each rail comprises parallel inner and outer rails.

21. The door of claim 20, wherein the outer rail is shorter than the inner rail and terminates short of the respective rail end.

22. The door of claim 19, wherein each side truss further comprises a plurality of lateral supports extending at spaced intervals between the rails and the respective side member.

23. The door of claim 22, wherein one of the lateral supports of each side truss extends from the apex of the side truss towards the respective door side member and has an end secured to the respective side member.

24. The door of claim 22, wherein each lateral support comprises an inner support member and an outer support member extending alongside the inner support member.

25. The door of claim 24, wherein the outer support member is shorter than the inner support member.

26. The door of claim 22, wherein each side truss further comprises angle braces extending at an angle between each adjacent pair of lateral supports.

27. The door of claim 26, wherein the lateral supports of each side truss have first ends secured to the rails and second ends secured to the respective door side member, and the angle braces extend alternately from the first end of a first lateral support to the second end of a second lateral support, and from the second end of the second lateral support to the first end of a third lateral support.

28. The door of claim 19, wherein the bracket of the first side truss is pivotally connected to the second end of the first hydraulic cylinder.

29. The door of claim 19, wherein the first rail is longer than the second rail.

30. The door of claim 17, further comprising a plurality of elongate frame members extending between the upper and lower horizontal ends of the door parallel to the first and second sides of the door, and at least one additional load bearing support truss mounted to one of the elongate frame members and extending parallel to the first and second side trusses, the additional support truss being substantially V-shaped.

31. The door of claim 30, further comprising a plurality of additional load bearing support trusses mounted to spaced elongate frame members between the first and second sides of the door.

32. A load distributing side truss for an overhead door mountable in an opening of a building to be closed by the door, the side truss comprising:
a generally V-shaped frame having an apex and opposite first and second ends and configured for attachment to one side of an overhead door so as to extend along substantially the entire length of the side of the door in a plane perpendicular to the door, whereby the V-shaped frame extends in a generally downward direction when the door is in a substantially horizontal, overhead open position;
the frame having a first rail extending from a first end to the apex and a second rail extending from the second end to the apex and connected to the first rail at the apex, and a plurality of spaced lateral supports extending laterally from the first and second rails, each rail having an end configured for connection to a portion of a door side member; and
the apex of the frame having a pivot mount configured for pivotal connection to the end of a hydraulic cylinder adapted for moving the door between open and closed positions.

33. The side truss of claim 32, wherein each rail comprises parallel inner and outer rails.

34. The side truss of claim 33, wherein the outer rail is shorter than the inner rail and terminates short of the respective rail end.

35. The side truss of claim 32, wherein one of the lateral supports extends from the apex of the side truss.

36. The side truss of claim 32, wherein each lateral support comprises an inner support member and an outer support member extending alongside the inner support member.

37. The side truss of claim 36, wherein the outer support member is shorter than the inner support member.

38. The side truss of claim 32, further comprising angle braces extending at an angle between each adjacent pair of lateral supports.

39. The door of claim 38, wherein the lateral supports have first ends secured to the rails and second ends adapted for connection to the door side member, and the angle braces extend alternately from the first end of a first lateral support to the second end of a second lateral support, and from the second end of the second lateral support to the first end of a third lateral support.

40. The side truss of claim 32, further comprising a bracket connecting the first and second rails together at the apex of the triangular frame.

41. The side truss of claim 40, wherein the bracket includes the pivot mount.

42. The side truss of claim 32, wherein the rails and lateral supports are made of steel rectangular tubing.

43. An overhead door for a building having an opening to be closed by the door, comprising:
an upper member, a lower member, and a pair of vertical members extending between the respective opposite ends of the upper and lower members to define opposite sides of the door, the members together defining a rectangular outer periphery of the door, the upper member being configured for pivotal mounting in the upper end of a door frame surrounding a building opening, whereby the door is movable from a vertical closed position to an upper, substantially horizontal open position;
a plurality of spaced, additional vertical members extending between the upper and lower members and parallel to the vertical members defining the opposite sides of the door; and
at least two load bearing support trusses secured to respective spaced vertical members of the door to extend along at least substantially the entire length of the respective vertical member in a direction transverse to the plane of the door, each support truss being substantially V-shaped and having an apex which extends generally downwards in the open position of the door and inwards in the vertical closed position of the door.

44. The door of claim 43, wherein at least a first one of the support trusses is secured to one of the vertical members which defines a side of the door, and the apex of the first support truss has a pivot mount configured for pivotal connection to one end of a hydraulic ram for opening and closing the door.

45. The door of claim 43, wherein at least one of the support trusses is secured to one of the vertical members spaced from the opposite sides of the door.

46. The door of claim 45, wherein a plurality of support trusses are secured to respective spaced vertical members across the width of the door.

47. The door of claim 44, wherein a second support truss is secured to the vertical member defining the opposite side of the door.

48. The door of claim 47, wherein at least one additional support truss is secured to one of the vertical members spaced between the opposite sides of the door.
